(19) United States
(12) Patent Application Publication
(10) Pub. No.: US 2010/0208467 A1
(43) Pub. Date: Aug. 19, 2010

(54) FREE-FORM REFLECTOR ARRAY TRANSFORMING A COLLIMATED BEAM INTO PRESCRIBED ILLUMINATION

(76) Inventor: Oliver Dross, Koln (DE)

Correspondence Address: DRINKER BIDDLE & REATH;ATTN: INTELLECTUAL PROPERTY GROUP, ONE LOGAN SQUARE, SUITE 2000, PHILADELPHIA, PA, 19103-6996, US

(21) Appl. No.: 12/681,987

(22) PCT Filed: Oct. 7, 2008
(86) PCT No.: PCT/US08/11584

§ 371 Date: Apr. 7, 2010

(30) Foreign Application Priority Data
Oct. 12, 2007 (US) 60998836

(51) Int. Cl. F21V 7/04; G02B 5/10

(52) U.S. Cl. 362/297; 359/838; 359/851

(57) ABSTRACT

An array of reflectors that transform a collimated beam into one that uniformly illuminates a specific patch of target surface, in particular obliquely presented rectangles, such as billboards. Each reflector is square, with a concave shape that uniformly illuminates a rectangular target. An algorithm is disclosed for producing a shape appropriate for any given illumination geometry. An array of such reflectors can be utilized with a nonuniform collimated beam and still produce uniform illumination. Hexagonal reflectors could also be arrayed to illuminate a hexagon, or an obliquely presented circle in the case of a collimated input beam with some divergence, which causes a blurring of the cutoff at the edges of the target. Non-tiling shapes such as alphanumeric characters will require some of the light of the collimated beam to be discarded. Reflector shapes and methods of calculating such shapes are also disclosed.

### CROSS-REFERENCE TO RELATED APPLICATION

This application claims benefit of U.S. Provisional Patent Application No. 60/998,836 in the name of Oliver Dross, filed Oct. 12, 2007, which is incorporated herein by reference in its entirety.

### BACKGROUND OF THE INVENTION

Luminaires for large signs are necessarily placed at oblique angles so as not to come between sign and viewer. The less oblique the angle the easier it is to get some light onto the farthest corners of the target, but the farther out this puts the luminaire, usually requiring stronger and thus costlier structural support. Conventional luminaires typically must overload the nearest part of the sign in order to get even a little light to the farthest corners, so that non-uniform illuminance is the norm. Only the human eye's great adaptability allows such failings to pass muster. Where they do not, as in luminaires for paintings, the lamp must be relatively further out from the painting to achieve the necessary degree of uniformity. Such an application would benefit from a luminaire that could be mounted closer to a painting and still be uniform.

The large source sizes of conventional lamps preclude “wall-washing” luminaires from achieving anything but great non-uniformity on oblique targets. The small size of light emitting diodes (LEDs), however, makes it possible to achieve the great angular variations in intensity required for oblique luminaires, where the cos⁻³ effect is substantial (factor of 7 increase from 50° to 70.4°). Only a luminaire that is substantially larger (factor of 10 or more) than its light source could deliver that great a variability in output intensity.

While illumination lenses have been patented, they all remain fundamentally limited by the large incidence angles required to deflect light refractively. Large incidence angles, such as the 50° required for a 20° deflection, engender distortion, chromatic dispersion, and large reflective losses. Lenses are favored for LEDs because the emission of an LED is typically hemispheric, with circuit boards and other structures behind that hemisphere, generally ruling out reflectors for anything but auxiliary cups next to the emitting chip. But the small size of LEDs means that very narrow collimation angles of only a few degrees can be achieved, as for example by the RXI lens disclosed in commonly-assigned U.S. Pat. No. 6,896,381 by Benitez et al.

A well collimated beam of light can be redistributed to a prescribed intensity pattern, such as for LED automotive high-beams, by the methods disclosed in commonly assigned U.S. Pat. No. 7,042,655 by Sun et al. This method requires uniform illuminance across the beam, which cannot always be taken for granted. It also becomes difficult to apportion a round beam onto a square target without spillage or shadowing. While the method of the present application can be applied to such lenses, its primary application is to reflectors that redistribute a collimated beam into any desired pattern. Reflectors are particularly advantageous for this task because their deflection angle is twice the incidence angle, in contrast to refraction's factor of (n−1)/n (=⅓ for a material with a refractive index of 1.5). Thus relatively small values of surface curvature can generate considerable changes in deflection, which is indispensable for the large variations in intensity required for oblique presentation. This is where the degree of collimation is crucial. Before LEDs, collimation angles of only a few degrees was confined to large searchlights. A 3° beam divergence means that the edge of the illumination pattern can fall to zero in no smaller an angle than this. The present systems contemplate that the beam divergence of the input collimation is less than a fifth the smallest angular extent of the target, and more preferably a tenth.

### SUMMARY OF THE INVENTION

With the advent of light emitting diodes (LEDs) in illumination, it has become possible for compact lenses to generate very narrowly collimated beams (i.e., only a few degrees). It is possible for a suitably shaped mirror to transform such a beam into a divergence that illuminates a desired target. Of particular interest as targets are nearby rectangles, such as paintings, billboards, and sides of buildings. An objective of the present invention is to provide such mirror shapes and how they can be made small and arrayed over a few inches to cover a collimated beam.

Embodiments of present invention may include two core ideas. First, a curved rectangular mirror can, at the proper tilt from a collimated beam, generate uniform illuminance on an oblique rectangular target. But conventionally this uniformity was only guaranteed by uniform beam illuminance, which is difficult to guarantee.

Second, when such a rectangular reflector is much smaller than the collimated beam, illuminance across it will vary very little, so that any beam non-uniformities will not show up in the mirror's output pattern. One preferred embodiment of the present invention is a circular array of many such small rectangular mirrors, joined at the same tilt, each producing the same pattern on the target. The principles of shaping the mirror in accordance with the particular target are disclosed herein and the polynomial coefficients are listed for several typical target presentations.

The angular outputs of luminaires can be classified as narrow (collimated, under 10 degrees wide), intermediate (15-40°), and wide-angle. The present invention best addresses the intermediate niche, particularly the most awkward and difficult targets for lenses, obliquely presented rectangles. Illumination patterns of arbitrary shapes such as letters can just as well be generated as rectangular illumination patterns, by a reflective array of similarly shaped minor elements. Most outlines, however, do not tessellate, or tile without leftovers, as nicely as rectangles or hexagons, posing a cost of lost light and the extra production step of masking the unwanted mirror sections between the array elements. Thus the principal emphasis of the preferred embodiments disclosed herein is on rectangles. In particular, billboard lighting faces limitations on both total lumens and the amount of spilled light. The present invention addresses this situation by delivering uniform illumination to a rectangle, with a sharp cutoff.

Embodiments of the present invention provide reflectors, arrays of reflectors, optical systems including such reflectors and/or arrays in combination with light sources, collimators, and/or targets to be illuminated, and methods of designing such reflectors, arrays, and systems.

According to one embodiment of the invention, there are provided a curved specular reflector, and a method of designing such a reflector, having a shape that reflects a collimated input beam onto a target, said reflector shape mathematically determined from the target geometry by a two-step integration of normal vectors that bisect the angles between said input beam and points on said target, the first of said two steps comprising the integration up the center of said reflector to yield a central spine, the second step comprising the lateral integration of horizontal ribs proceeding from each point on said spine.

According to another embodiment of the invention, there are provided a curved specular reflector, and a method of designing such a reflector, that when exposed to a uniform collimated beam with a direction defining a negative z-axis will uniformly illuminate a planar target at distance z₀, said target being M times larger than said reflector, said reflector described by the mathematical function

$$\begin{matrix}z = h ( x , y ) \\ = \frac{ln [ 2 ] - 1 - ln [ 1 + \sqrt{1 + {A}^{2} {x}^{2}} ] + \sqrt{1 + {A}^{2} {x}^{2}}}{A} + \\ \frac{ln [ 2 ] - 1 - ln [ 1 + \sqrt{1 + {a}^{2} ( x ) {y}^{2}} ] + \sqrt{1 + {a}^{a} ( x ) {y}^{2}}}{a ( x )}\end{matrix}$$

$$wherein$$

$$a ( x ) = \frac{M}{\sqrt{{z}_{0}^{2} + {M}^{2} {x}^{2 }}}$$

and A=MX/z₀, with X being the x-coordinate of the mirror outer edge.

According to another embodiment of the invention, there are provided an illumination system, and a method of designing an illumination system, comprising a target; an array of reflectors according to the invention, and a collimator for delivering a collimated input beam along the z axis, said input beam of angular beamwidth less than one fifth the angle subtended by said target at said reflector, the array being held oriented to said beam in operation.

According to further embodiment of the invention, there are provided a mirror system and a method of designing a mirror system comprising an array of mirrors, each oriented to illuminate substantially the whole of a common target substantially uniformly from a common input beam of collimated light.

### BRIEF DESCRIPTION OF THE DRAWINGS

The above and other aspects, features, and advantages of the present invention will be more apparent from the following more particular description of embodiments thereof, presented in conjunction with the following drawings wherein:

FIG. 1A is a perspective view of a reflective wall-illumination mirror.

FIG. 1B is a side view of same, with rays.

FIG. 1C is a side view showing the rays going to a screen.

FIG. 1D is a front view of rays and screen.

FIG. 2 is a side view of a tilted system.

FIG. 3 is a graph of the reflector spine.

FIG. 4 is a perspective view of the spine with ribs.

FIG. 5A shows a Runge-Kutta iteration of the spine.

FIG. 5B shows the parabolic approximation to the spine.

FIG. 6A shows a Runge-Kutta iteration of a rib shape.

FIG. 6B shows the parabolic approximation to the rib.

FIG. 7 shows a graph of the rib shapes.

FIG. 8 shows the local coordinates for manufacturing the mirror shape.

FIG. 9 shows a circular array of rectangular mirrors.

FIG. 10 shows gaps between mirror elements.

FIG. 11 shows a circular array of hexagonal mirrors.

FIG. 12 shows the analytical derivation of the reflector slope.

FIG. 13A shows analytical integrations of the reflector slope function.

FIG. 13B shows the specific curves corresponding to FIG. 3 & FIG. 7.

FIG. 14 is a graph of a constant-intensity reflector.

### DETAILED DESCRIPTION OF THE DRAWINGS

The reflectors of the present invention are designed by a flux mapping procedure that scans a target, generates a list of required normal vectors, and derives the reflector shape from that list by numerical integration. Any rectangular target can be illuminated by a square reflector, and any target would be expected to be presented symmetrically. Laterally offset targets, however, would require reflectors that were similarly asymmetric, but they would actually be sections of a notional larger symmetric reflector designed for a notional larger symmetric target that included the actual asymmetric one. Thus reflectors without right-left symmetry do not fall outside the scope of the present invention, however infrequently they may be needed. Accordingly, the following Figures only show symmetric illumination-configurations.

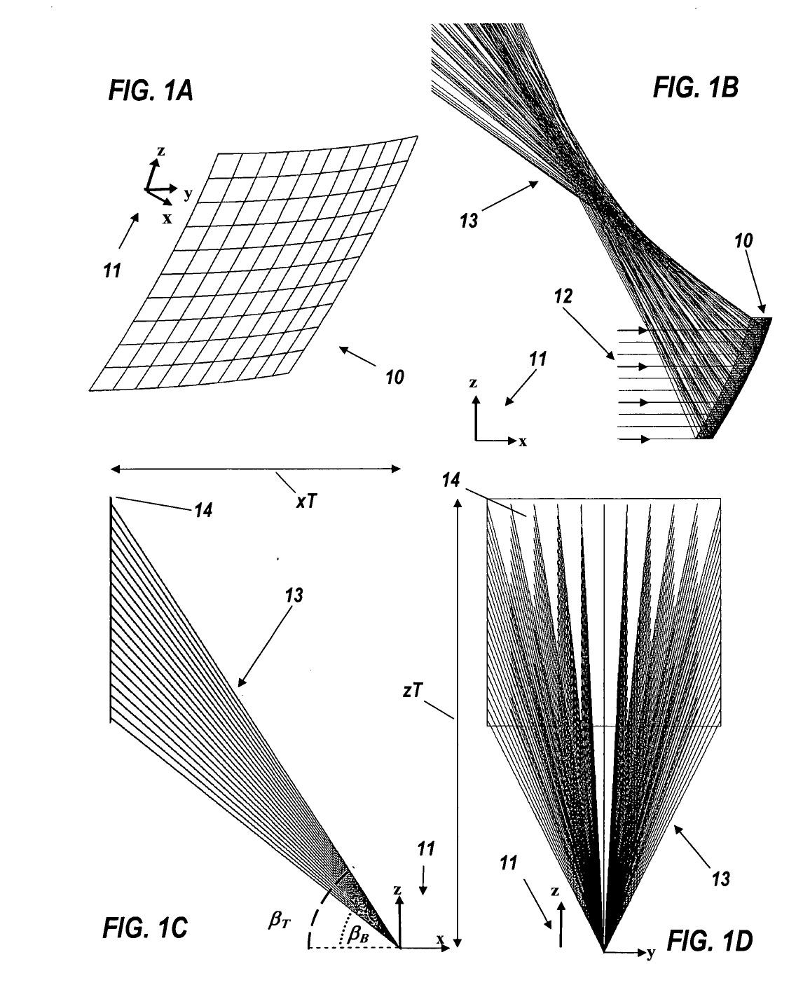

FIG. 1A is a perspective view of curved rectangular mirror 10, with orientation shown by coordinate-axis triad 11. Mirror 10 has been ruled with a checkerboard pattern to show its shape.

FIG. 1B is a side view of mirror 10 and mathematical coordinate triad 11, also showing collimated rays 12 and reflected rays 13.

FIG. 1C is a side view of reflected rays 13 expanding to illuminate target screen 14, and FIG. 1D is a front view of same, showing the good coverage of the target by the rays. Rays 13 can be seen to form a rectangular grid as they expand to cover screen 14. Their uniform spacing is proportionally the same as that of the grid (not shown) formed by input rays 12 of FIG. 1B. The essential aspect of the invention is that uniform illumination by a collimated input beam is transformed by reflection of its unique shape to form a diverging beam which will produce uniform illumination of a rectangle (in this case a square). A collimated beam need not be as perfectly parallel as a laser beam in order to function as input to the present invention. It need only be composed of substantially parallel rays, which in this case is understood as sufficiently parallel so as not to excessively blur the edge of the pattern. For example, the target 14 in FIG. 1C subtends 18° at the reflector 10 so that the input beamwidth should be, say, a fifth of this, or ±2°.

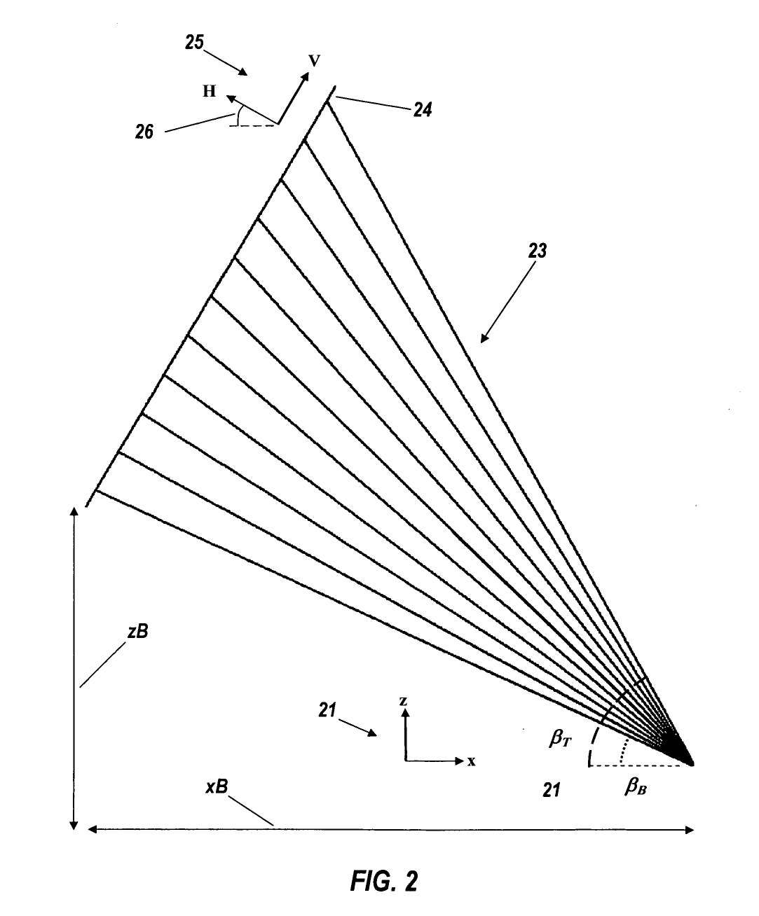

FIG. 2 is a side view of a tilted configuration, with coordinate axes 21, illumination beam 23, and tilted target 24. Ground coordinates 25 show how the tilt angle 26 is actually that of the system and not of the screen. Having the system x axis coincide with the collimating input beam (not shown) is mathematically convenient for deriving the mirror shape.

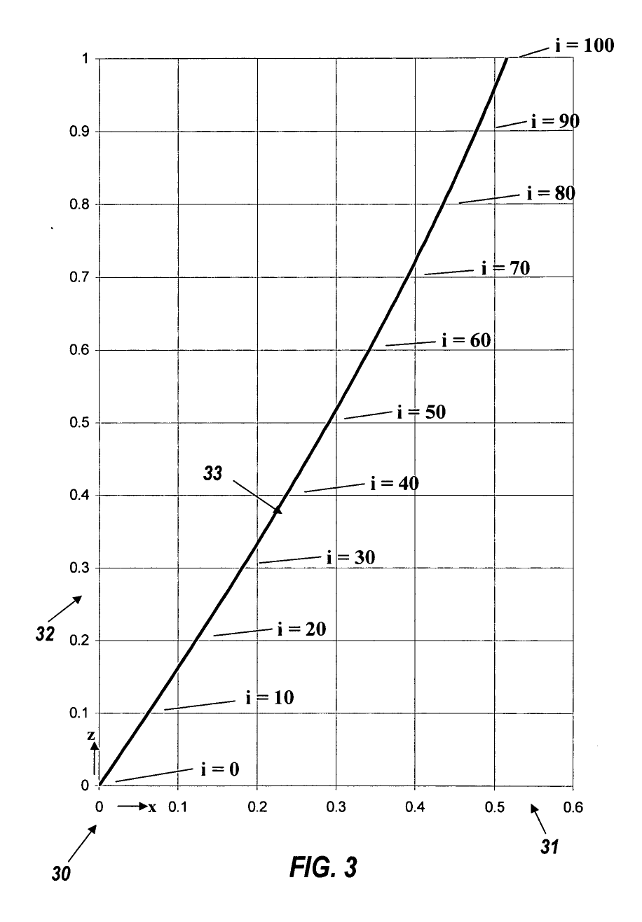

FIG. 3 shows graph 30 with horizontal axis 31 and vertical axis 32. In this and subsequent Figures, the mirror has unit height and width, with millimeter units contemplated for arraying many such mirrors. In FIG. 3, central profile 33 is the same as the rightmost curve in the side view of FIG. 1B. The low curvature of central profile 33 is readily apparent, and is the reason for the good fit of rays 13 to target 14 shown in FIG. 1D. As aforementioned, mirrors have the advantage as deflectors over lenses, in that reflectors attain a deflection that is twice the incidence angle. Thus the field curvature of the target is cut in half in the mirror, so there is negligible distortion of the output beam. All the profiles shown herein are concave, because the output beam is converging as it leaves the mirror, rather than diverging directly to the target. A directly diverging beam disadvantageously precludes any bordering structure such as a light shield. The diverging profile, however, is obtained merely by turning FIG. 3 upside down and shining light from the right side. Thus the diverging mode is as equally covered as the converging mode in all Claims and Figures herein.

Central profile 33 of FIG. 3 was calculated and graphed in a Microsoft Excel spreadsheet in accordance with the above disclosed algorithm, for N=100 points, with every tenth one indicated in FIG. 3. The slope at the i=0 start point (0,0) is m[0], with its value being such as to deflect a horizontal ray to the top of the target, while at the (i=N) finish point on the mirror's top at Z=1, slope m[N] is such that a horizontal ray is deflected to the bottom of the target.

The target is in this case vertically oriented, but a tilted target is equally serviceable by the present invention. As shown in FIG. 1, the angle to the top of the target, which is at horizontal distance x_{T} and vertical distance z_{T}, is β_{U}=tan⁻¹(z_{T}/x_{T}). The local tilt from the vertical will be half this, and its slope will be the inverse of the tangent of this tilt, so that m[0]=cot(½β_{T}). The corresponding angle and dimensions for the bottom of the screen are shown in FIG. 2 for the tilted case, so that m[N]=cot(½β_{B}) for β_{B}=tan⁻¹(z_{B}/x_{B}). For all intermediate points, the mirror slopes are obtained from target coordinates xₜ[i] and zₜ[i], which are linearly interpolated between x_{T} and x_{B}, and z_{T} and z_{B}, respectively. This will cover the case shown in FIG. 2 of a target tilted forward, which is mathematically equivalent to a tilted delivery of the collimated beam, but a horizontal beam is mathematically more convenient for generating the mirror shape, acting as a standard for comparing different embodiments.

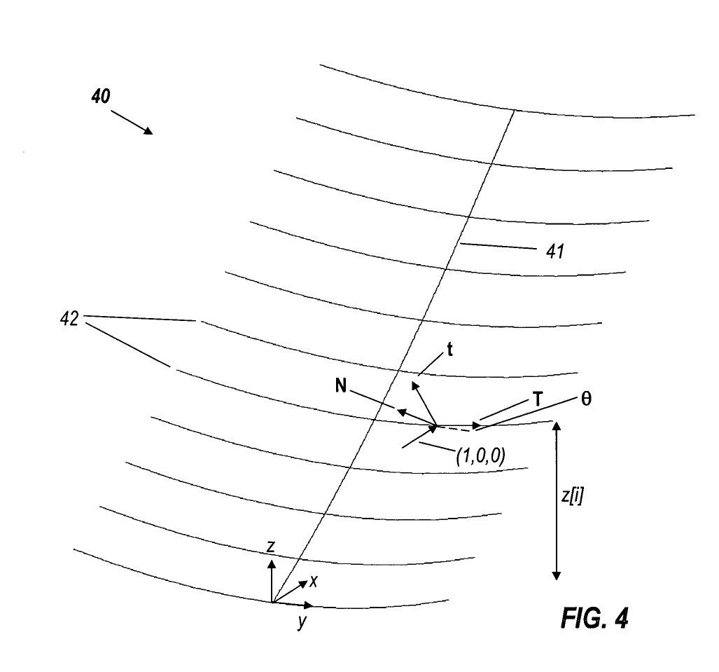

Vertical profile 33 of FIG. 3 is a kind of central spine of the mirror, in that the remainder of the surface is generated from it by lateral curves acting like ribs, as shown in FIG. 4. Skeleton 40 comprises spine 41 and lateral ribs 42. Spine 41 is in the x-z plane, at y=0, while ribs 42 are in x-y planes defined by each of the zᵢ values along the spine. Mirror symmetry about the spine is assumed, since symmetric illumination of a target is the case for the overwhelming majority of rectangular applications.

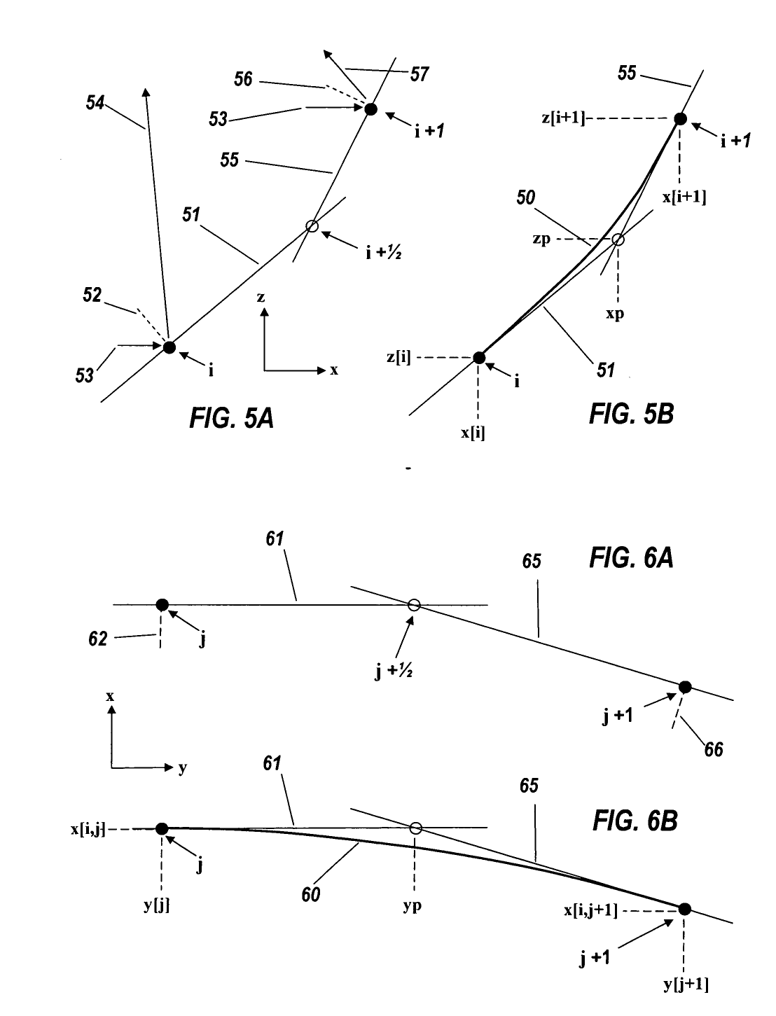

Vertical profile 33 of FIG. 3 was calculated from the list of 100 slopes mₙ, proceeding point by point from the bottom of the mirror at z=0 to finish at z=1, the top. Every tenth value of i is shown on the right of FIG. 3. For each value of i, there was an iterative step that calculates from a known position and slope the x coordinate of the next point, of known slope. To elucidate one such step, FIG. 5A shows two such points, i and i+1, with their slope differences grossly exaggerated. Line 51 is tangent to the mirror at point i, with dotted line 52 the corresponding normal. Horizontal ray 53 is reflected to become upward ray 54 proceeding to the top of the target (not shown, but similar to FIG. 1C). Point i+1 is at a known vertical location z[i+1] but unknown horizontal location x[i+1]. Line 55 is tangent to the mirror at point i+1, so that the horizontal location of point i+1 will be the one that makes line 55 intersect with tangent line 51 at point i+½, at a height halfway between z[i] and z[i+1]. Tangent line 51 has the general equation

z=z[i]+m[i](x−x[i])=m[i]x+b[i]

where the z intercept of tangent line 51 is

b[i]=z[i]−m[i] x[i]

Then intermediate point i+½, at known height

zp=½(z[i]+z[i+1])

will be at the intermediate x-coordinate

xp=(z[p]−b[i])/m[i].

Tangent line 55 has the equation

z=zp+m[i+1](x−xp)=m [i+1]x+b[i+1]

with its z-intercept thus given as

b[i+1]=z[p]−m[i+1]xp.

Then point i+1 is fixed by

x[i+1]=(z[i+1]−b[i+1])/m[i+1]

and so another iteration step is completed, classified as the Runge-Kutta type.

FIG. 5B shows parabolic arc 50, which is uniquely determined by being tangent to both tangent lines 51 and 55. Any point (x,z) along it can be described by varying the parameter s between 0 and 1 in calculating

x=(1−s²)xᵢ+2s(1−s)xₚ+s²xᵢ₊₁ and

z=(1−s²)zᵢ+2s(1−s)zₚ+s²zᵢ₊₁.

This accurate parabolic approximation is used in many ray-tracing programs.

As aforementioned, only one side of each bilaterally symmetric rib need be calculated, for 0<y<½. As shown in FIG. 6A, for each of a spine's points i=0 . . . N, there is a rib specified by a list of y coordinates y[j] indexed by j=0 . . . ½N, spaced at even intervals Δy=0.5/N along the y axis. In general, the mirror shape is determined by calculating the coordinate values x[i,j] for the known grid values y[j]=jΔy and z[i]=iΔz, with Δz=Δy for a square mirror. The previously calculated central spine is more generally designated as x[i,0]. For each of the N ribs, there are N/2 points on each side of the spine. First their slopes mₕ[i,j] are determined from the requirement of reflecting the horizontal input beam onto the corresponding equally spaced points on the target. A rectangular rather than square target merely means different y and z spacings on the target, but the mirror may remain square.

Even for a rectangular target, a square mirror is preferable, since it is the most compact rectangle and thus best to use in a mirror array. Illumination across it is assumed to be uniform in all mirror-shape calculations herein. While this is presumptuous for large-scale mirrors, in an array of small mirrors, as shown in FIG. 9, the illumination across any one of them will be very close to uniform, removing the difficult requirement for producing a rectangular collimated beam that is spatially uniform. However, the target and/or the mirror may be a rectangle other than a square, and/or the number of calculated points, which in this example is an N+1×N+1 square array, may be different in the two directions.

As shown in FIG. 4, each rib 42 is a horizontal curve of constant height z[i]. The shape of each rib is determined by the set of normal vectors necessary for the points along it to reflect the collimated beam, which has its unit vector (1,0,0) along the x axis. Each point (x[i,j],y[j],z[i]) on the i^{th} rib reflects the input beam towards the corresponding target point (xₜ[i], yₜ[j], zₜ[i]). which lie along the i^{th} horizontal line on the target. This is shown by direction vector t in FIG. 4, with the resultant normal vector N bisecting the input and output vectors. In the case of FIG. 1C, target 14 is vertically oriented and all points on it have the same value of xₜ. Because a mirror system cannot reflect light back towards the collimator, situations without the vertical target-offset of FIG. 1C, such as in billboard lighting, will require the entire system to tilt downwards, as shown in FIG. 2, relative to the axis of the collimated light. This classifies the reflector as off-axis.

Because the mirror is so much smaller than the target, the distance to each target point, in the coordinates of FIG. 1C and FIG. 1D, is merely

rₜ[i,j]=√(xₜ[i]², yₜ[j]², zₜ[i]²)

and the unit vector corresponding to it is

(xₜ[i], yₜ[j], zₜ[i])/rₜ[i,j].

As shown in FIG. 4, the horizontal input beam has the unit vector (1,0,0). Then the normal vector N will be

(xₜ[i]−rₜ[i,j], yₜ[j], zₜ[i])/rₜ[i,j]

remembering that xₜ[i]<0 by convention, as in FIG. 1. As shown in FIG. 4, each point on a horizontal rib has in the x-y plane a unit tangent vector T=(Tₓ, T_{y}, 0) that must be perpendicular to the normal vector, so that

Tₓ(xₜ[i]−rₜ[i,j])+T_{y} yₜ[j]=0

As shown in FIG. 4, tangent vector T subtends an angle θ from the y-axis, which for all points forms a matrix of values θ[i,j], so that Tₓ=sin θ[i,j], T_{y}=cos θ[i,j], and

tan θ[i,j]=yₜ[j]/(rₜ[i]−xₜ[i,j]).

In FIG. 6B, for each rib-generating iteration step from y[j] to y[j+1], the intermediate value is

yp=½(y[j]+y[j+1])=(j+½)Δy

for which the corresponding unknown x-coordinate xp must be calculated.

FIG. 6A depicts the iteration step from j to j+1, with the j^{th} tangent shown as line 51 through known point j. As previously, the intermediate point j+½ is at x-coordinate

xp=x[i,j]+½Δy tan θ[i,j].

To complete the iteration step, from xp the desired x-coordinate of the next point is

x[i,j+1]=xp+½Δy tan θ[i,j+1].

FIG. 6B depicts a parabolic approximation of the same type as FIG. 4B.

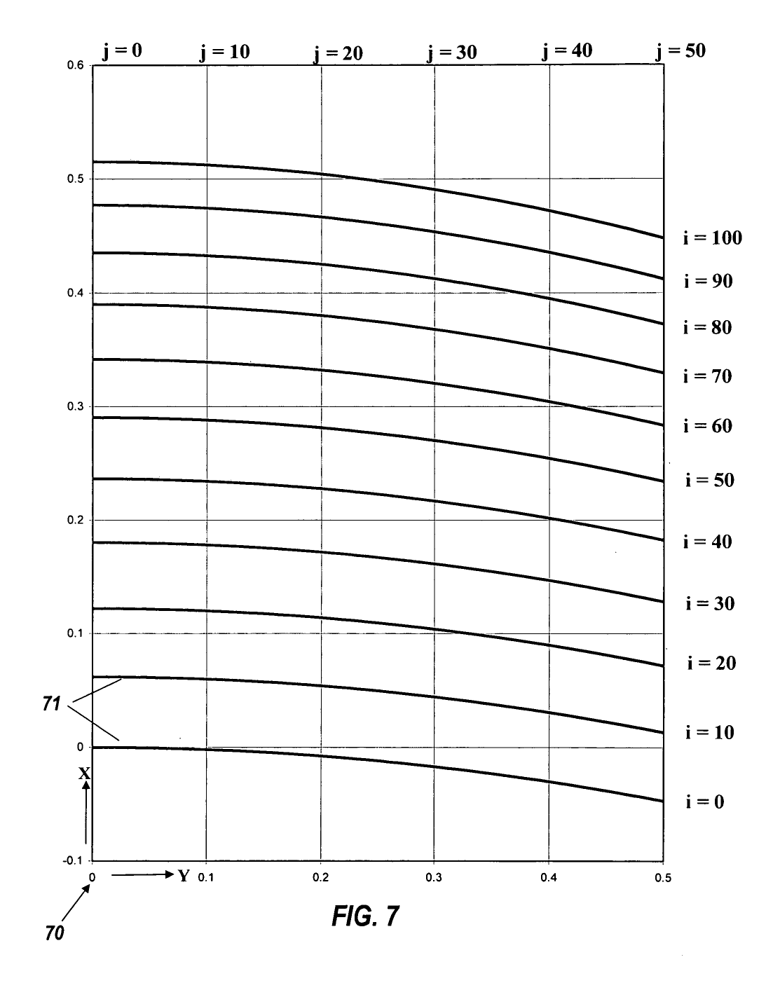

As produced from a spreadsheet rendition of the rib algorithm, FIG. 7 shows graph 70, which plots the x-y profiles 41 of various ribs, labeled every 10 points from i=0 to i=100, as well as the y-locations of the j values j=0 to j=50.

The shape generation algorithm just described gives numerical coordinates, (x,y,z) triads of both the tangent points defining the surface, as well as the intermediate points where the tangents intersect. Specification of these enables the specification of a unique parabola with tangents at both points. This is analogous to a Runge-Kutta numerical solving of a differential equation. Making the calculation interval, or spatial iteration step, small enables a good fit, after which the data could be down-sampled to a suitably coarser resolution.

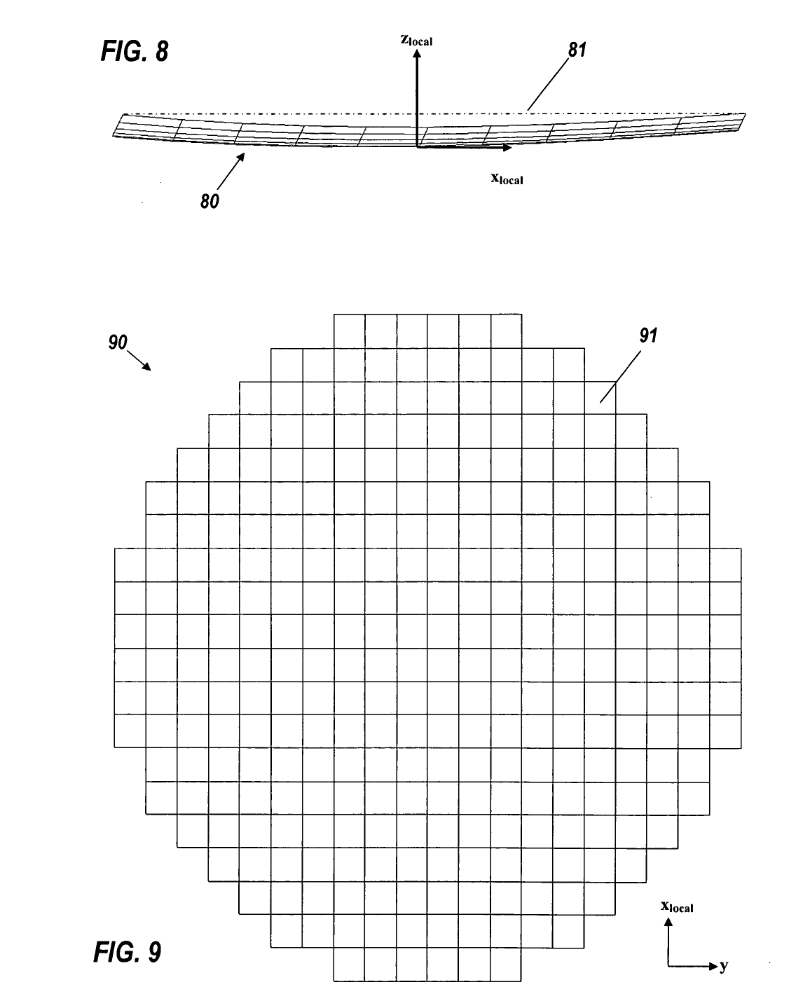

A more compact way to specify a surface is a polynomial fit with a RMS error only a fraction of an optical wavelength. Numerical experimentation with a standard surface fit program is simplified if the numerical coordinates are expressed in the plane of the mirror concavity. FIG. 8 shows reflector 80 as it would be oriented in the plane 81 defined by the reflector's corners. Reflector 80 thereby lies horizontally in its own local coordinate system comprising (x_{L}, y_{L}, z_{L}) triads, hereinafter re-named (X,Y,Z) so that the following equations are less cluttered.

The surface of FIG. 8 can more advantageously be expressed as a polynomial, and its small 1mm size means that a quarter-wave figural accuracy will suffice to keep reflection errors much smaller than the angular width of the collimated beam. This in turn means that a polynomial Z=f(X,Y) need only be of second-degree. Due to the y-symmetry of a central placement of the illuminator over the target, the first-order y-terms drop out, leaving the terms

Z=A+CY²+DX+FXY²+GX²+IX²Y².

At the coefficient-fitting Web-Site, www.zunzun.com, the coefficients of Table 1 were obtained from an 11×11 matrix of surface points of parameter variations of FIG. 6, with the middle column defined by FIG. 7.

Although NURB surfaces are useful in the programming of the figuring machine that will produce the insert for an injection mold for the array of FIG. 8, a polynomial specification is more compact. It is possible to list the coefficients for different screen geometries, and their RMS figural error for a 1 mm reflector width, as listed in Table 1, with the previously generated and illustrated reflector listed in the third column.

TABLE 1
Second-Order Coefficients for Three Configurations

| | | | |
|---|---|---|---|
| Screen Distance, mm | 800 | 1200 | 1500 |
| Screen Bottom, mm | 500 | 1000 | 1200 |
| Screen Height, mm | 1080 | 1500 | 1200 |
| Screen Width, mm | 1960 | 1500 | 1200 |
| TILT | 66.05° | 63.56° | 65.58° |
| A | 0.003506 | 0.001455 | 0.0003639 |
| C | 0.393134 | 0.198424 | 0.140793 |
| D | −0.027881 | 0.015638 | −0.007438 |
| F | 0.158188 | 0.080851 | 0.039323 |
| G | 0.117373 | 0.091468 | 0.075255 |
| I | 0.025097 | 0.018327 | 0.005206 |
| RMS Error, μ (1 mm) | 0.34 | 0.16 | 0.046 |

As previously mentioned, the mirror shape requires uniform illumination, something that only meticulous engineering can provide on a large scale. On a small scale, however, illuminance does not vary much over, say, a millimeter, across a 50 mm wide beam. Accordingly, if an array of 1 mm rectangles is formed as one piece, it would require much less material than a single large reflector. Most advantageously, the array can be a round shape. FIG. 9 shows array 90 of small rectangular reflectors 91, identical in form to reflector 10 of FIG. 1A, and so disposed as to have an approximately elliptical outline. The height of array 90 is greater than its width, so as to cover a round beam when tilted at the 65.6° from horizontal required by its target geometry. Thus a round beam can be transformed into a rectangular beam that uniformly illuminates an oblique target, something quite difficult with the prior art of illumination optics. As previously mentioned, non-oblique targets can be handled with a tilted system of the present invention, as shown in FIG. 2.

When a collimated beam illuminates any such array of many small illuminating mirrors, variations of its illuminance will not show up in the target illuminance distribution. This invariance also shows up when the collimated input beam comprises several adjacent beams of different colors, their flux weighted to combine into white. The mirror array will perfectly mix the colors at the target. While conventional color mixing becomes more difficult as more colors are added, the present array can easily be shaped to accept as many different wavelengths as desired. The use of 5 collimated LEDs of different wavelengths would give a color rendering index superior to that of the conventional three colors.

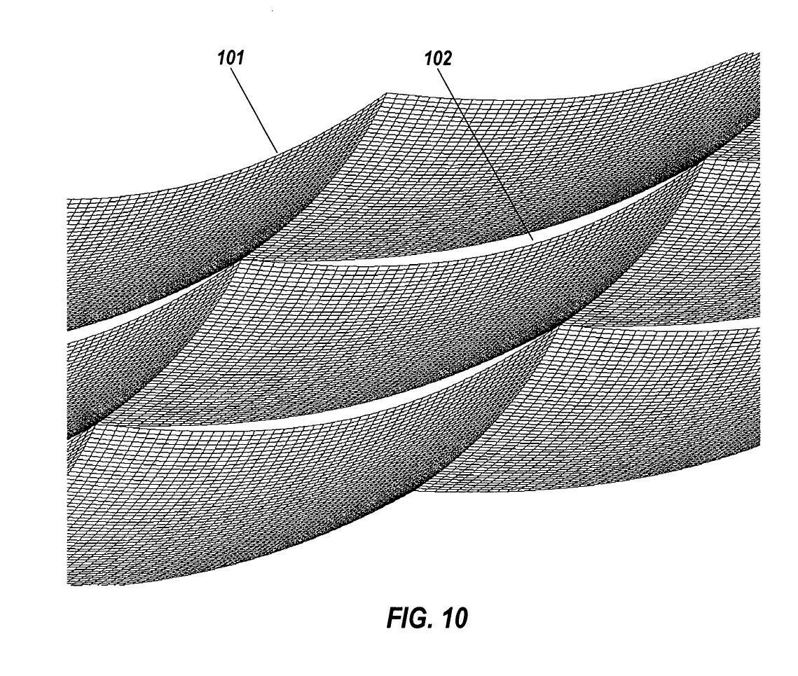

Because of the off-axis configuration of FIG. 1C, the adjacent mirrors will not match up in the x-direction. In FIG. 8 the left and right sides of reflector 80 are different. FIG. 10 is a close-up perspective view of several reflectors 101, showing gaps 102 between them. This will lead to cliffs in the injection-mold tool

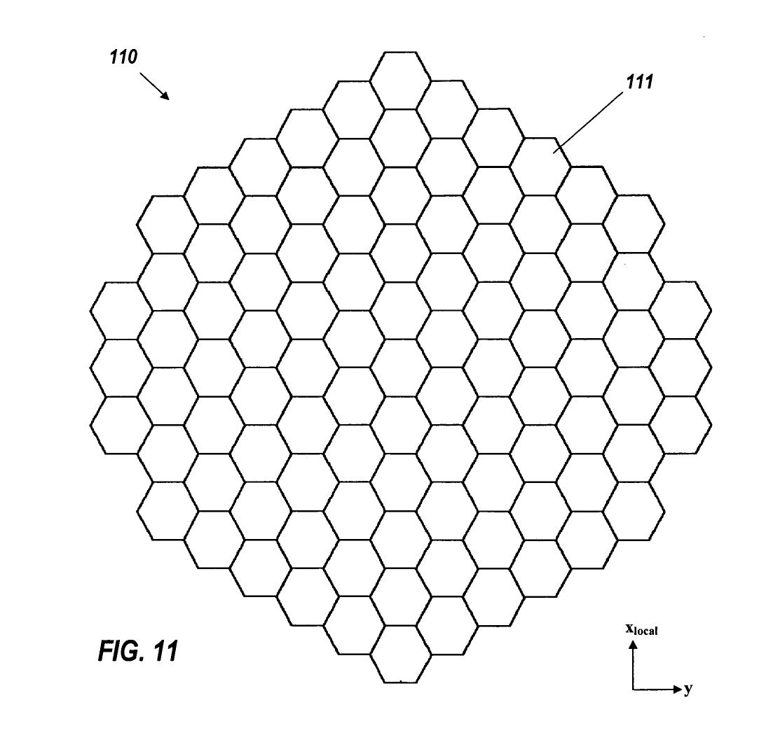

It is equally possible to form hexagonal mirrors and arrange them into an approximately circular array, as in FIG. 11 Hexagonal array 11 comprises hexagons 11 elongated vertically by 1/sin(65.6°)=1.1, the same factor as rectangles 91 of FIG. 9. More generally, mirrors of any shape desired, such as alphabetic characters, can be so arrayed, albeit with some losses because most planar shapes do not tile (i.e., cover a plane with no losses).

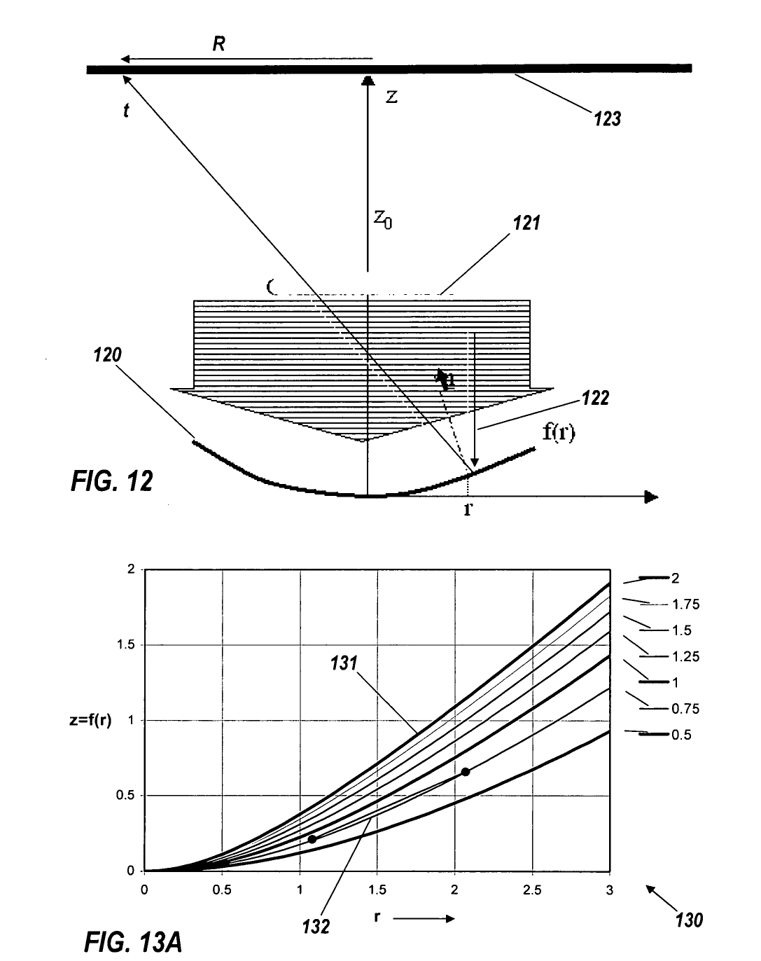

Besides the aforementioned numerical algorithm, it is also possible to analytically solve the differential equation of the mirror profile, once it has been cast into suitable two-dimensional (r,z) form, one that begins with a symmetrical on-axis mirror, as shown in FIG. 12, with horizontal coordinate r. Downward beam 121 uniformly illuminates reflector profile 120, which has shape expressed as a function z=f(r). At distance r from the center, incoming ray 122, represented by vector (0,−1,) is reflected out to a point on target 123 at distance R off-axis, defining the system magnification M=R/r. In actual situations, M would be about 1,000, far more than in FIG. 11, so that the vector t to the target point is (−R,z₀), Then normal vector n will bisect those two, and thus be given by n=[−R/√(R²+z₀²),1+z₀/√(R²+z₀²)], This becomes n=[−Mr, √(R²+z₀²)+z₀]/√(R²+z₀²). The normal vector is perpendicular to the slope, so that the minor slope is given by f′(r)=(√(M²r²+z₀²)+z₀)/Mr. Then form characteristic parameter a=M/z₀, enabling the solution to be expressed, given f(0)=0, as

$$f ( r ) = \frac{ln [ 2 ] - 1 - ln [ 1 + \sqrt{1 + {a}^{2} {r}^{2}} ] + \sqrt{1 + {a}^{2} {r}^{2}}}{a}$$

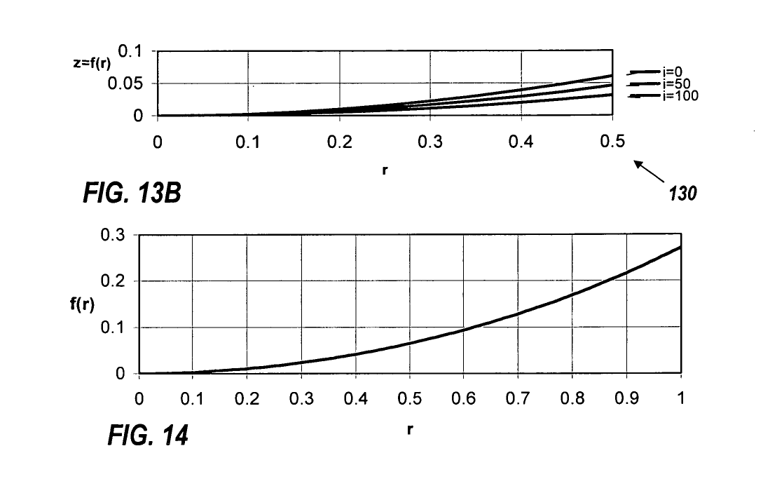

FIG. 13A shows graph 130 for z=f(r) out to r=3 with various curves 131 for values of parameter a running from 0.5 to 2. Each is half of a symmetrical reflector shape. All profiles will asymptotically reach a 45° slope. In the plane of FIG. 3 the x coordinate corresponds to coordinate z in FIG. 13A, and coordinate z in FIG. 3 corresponds to r in FIG. 13A. As shown in the third column of Table 1, the magnification is M=1200 and z0=1500, giving a=0.75, corresponding to the curve so labeled in FIG. 13A. Central profile 33 corresponds to segment 132 of that curve. This is an example of an off-axis segment of a reflector profile.

The lateral ribs shown in FIG. 4 and FIG. 7 also can be fit to this equation. FIG. 13B is a magnification of the lower left part of FIG. 13A, for 0<r<0.5. The values of a for the three curves shown come from using the diagonal distance √(xT²+zT²) of FIG. 1C in place of z₀ in the calculation of a, resulting in the three values of 0.424, 0.512, and 0.625 for the three curves of FIG. 13B labeled respectively, i=100, i=50, and j=0, which in turn correspond to the curves of FIG. 7 with the same labels.

In order to express the reflector shape in a single equation z=h(x,y), the spine z=g(x) will provide the f(0) values for each rib equation z=f(y) at a particular x. The equation for the spine merely has to use x values for the off-axis situation of FIG. 1C. Unfortunately, the analytical approach uses different coordinates than the optical system layout of FIG. 1C, namely the interchange of z and x. Thus the reflector of FIG. 3, running from z=0 below to z=1 above, will instead be expressed as going from x=2 below to x=1 above. The horizontal x-scale of FIG. 3 is similarly reversed in becoming the z axis, running from f(1) on the right to f(2) on the left. The a-parameter for the spine function z=g(x) will hereinafter be called A, and it will supply the boundary condition f(0) for the ribs. Also, for each rib f(y) the a-parameter is a function of x, namely

$$a ( x ) = \frac{M}{\sqrt{{z}_{0}^{2} + {M}^{2} {x}^{2}}}$$

Combining all these gives the surface equation for the reflector of FIG. 1A:

$$\begin{matrix}z = h ( x , y ) \\ = \frac{ln [ 2 ] - 1 - ln [ 1 + \sqrt{1 + {A}^{2} {x}^{2}} ] + \sqrt{1 + {A}^{2} {x}^{2}}}{A} + \\ \frac{ln [ 2 ] - 1 - ln [ 1 + {a}^{2} ( x ) {y}^{2} ] + \sqrt{1 + {a}^{a} ( x ) {y}^{2}}}{a ( x )}\end{matrix}$$

For FIG. 1A, M=1200 and z₀=1500, with the offset of xB=1200. This corresponds to the rectangle (1<x<2) and (−0.5<y<0.5).

The iterative algorithm that generates the reflector shape is more general than the analytic solution, since other prescriptions can be fulfilled as well, only some of which have analytic solutions. One such is constant far-field intensity I₀ generated out to an axial angle Θ, giving a total flux of Φ=2π I₀(1−cos Θ), which corresponds to the reflector radius rᵣ by Φ=π rᵣ², so that cos Θ=1−2 rᵣ²/I₀. Then the slope function is given by

$${f}^{′} ( r ) = tan ( Θ / 2 ) = \sqrt{\frac{1 - cos Θ}{1 + cos Θ}} = \sqrt{\frac{1}{{I}_{0}} \frac{{r}^{2}}{4 {I}_{0} - {r}^{2}}}$$

Imposing the boundary condition f(0)=0 makes this integrate to

$$f ( r ) = 2 - \sqrt{\frac{4 {I}_{0} - {r}^{2}}{{I}_{0}}}$$

Consider a case of a unit radius reflector that is to generate constant intensity out to an angle of 60°, so that Φ=π and I₀=1. This reflector shape is graphed in FIG. 14.

1. A curved specular reflector having a shape that reflects a collimated input beam onto a target, said reflector shape mathematically determined from the target geometry by a two-step integration of normal vectors that bisect the angles between said input beam and points on said target, the first of said two steps comprising the integration up the center of said reflector to yield a central spine, the second step comprising the lateral integration of horizontal ribs proceeding from each point on said spine.

2. The curved specular reflector according to claim 1, wherein the reflector and the area of illumination produced on the target are of the same shape.

3. The curved specular reflector according to claim 2, wherein the reflector and the area of illumination produced on the target are rectangular.

4. A curved specular reflector that when exposed to a uniform collimated beam with a direction defining a negative z-axis will uniformly illuminate a planar target at distance z₀, said target being M times larger than said reflector, said reflector described by the mathematical function
$$\begin{matrix}z = h ( x , y ) \\ = \frac{ln [ 2 ] - 1 - ln [ 1 + \sqrt{1 + {A}^{2} {x}^{2}} ] + \sqrt{1 + {A}^{2} {x}^{2}}}{A} + \\ \frac{ln [ 2 ] - 1 - ln [ 1 + \sqrt{1 + {a}^{2} ( x ) {y}^{2}} ] + \sqrt{1 + {a}^{a} ( x ) {y}^{2}}}{a ( x )}\end{matrix}$$
$$wherein$$
$$a ( x ) = \frac{M}{\sqrt{{z}_{0}^{2} + {M}^{2} {x}^{2}}}$$
and A=MX/z₀, with X being the x-coordinate of the mirror outer edge.

5. The reflector of claim 4, comprising an arbitrary boundary shape, said shape becoming the boundary shape of the illumination pattern at the target of said reflector.

6. The reflector of claim 5, wherein said boundary shape is an off-axis rectangle.

7. An illumination system comprising:
a target;
an array of reflectors according to claim 2; and
a collimator for delivering a collimated input beam along the z axis, said input beam of angular beamwidth less than one fifth the angle subtended by said target at said reflector, the array being held oriented to said beam in operation.

8. The illumination system of claim 7, comprising a target positioned to be illuminated by the light reflected from the array of reflectors.

9. The illumination system of claim 7, wherein each reflector in the array is configured to illuminate substantially the whole target with light reflected from the input beam.

10. The illumination system of claim 7, further comprising a light source configured to supply light to the collimator to produce the collimated beam.

11. The illumination system of claim 10, wherein said collimated input beam comprises multiple adjacent beams of differing wavelengths.

12. A mirror system comprising an array of mirrors, each oriented to illuminate substantially the whole of a common target substantially uniformly from a common input beam of collimated light.

13. The mirror system of claim 12, configured to illuminate substantially uniformly a flat target wherein an axis perpendicular to the plane of the target and centered on the array of mirrors is offset from the center of the illuminated area of the target.

14. The mirror system of claim 12, wherein the mirrors substantially tile the array.
